(19) United States
(12) Patent Application Publication
(10) Pub. No.: US 2018/0103695 A1
(43) Pub. Date: Apr. 19, 2018

(54) PROTECTIVE SHOCK-ABSORBING MATERIAL

(71) Applicant: JERRY A CHERNEY, NORTHBROOK, IL (US)

(72) Inventor: JERRY A CHERNEY, NORTHBROOK, IL (US)

(21) Appl. No.: 15/846,067

(22) Filed: Dec. 18, 2017

Related U.S. Application Data
(63) Continuation-in-part of application No. PCT/US16/37949, filed on Jun. 17, 2016.
(60) Provisional application No. 62/181,193, filed on Jun. 17, 2015.

(51) Int. Cl. A41D 13/015; A42B 3/06; A41D 13/05

(52) U.S. Cl. CPC A41D 13/0153; A42B 3/063; B32B 3/18; A41D 13/0543; A41D 13/0506

(57) ABSTRACT

The present invention relates to a material that includes a first elastic element and a second elastic element that are (a) adjacent but not contiguous in a resting state and (b) connected to a substantially inelastic element, wherein both of the elastic elements are disposed on the exterior surface of the material and the first elastic element or the second elastic element spreads laterally upon impact with an object.

### CROSS REFERENCE TO RELATED APPLICATIONS

This Application is a continuation-in-part (and claims the benefit of priority) of PCT/US2016/037949, filed on Jun. 17, 2016, which application is a continuation of Provisional Application Ser. No. 62/181,193, filed on Jun. 17, 2015, both naming Jerry A. Cherney as inventor. The disclosures of the prior Applications are considered part of and are incorporated by reference in their respective entireties in the disclosure of this Application.

### FIELD OF THE INVENTION

The invention described herein below relates to the field of impact-resistant materials as used, for example, on individuals to protect against injury due to accidental falls or purposeful collisions as well as on objects to protect against damage due to accidental drops or collisions.

### BACKGROUND OF THE INVENTION

It is an all-too-common occurrence that those with fragile bones suffer serious injury due to the merest of accidental impacts against an object or another person. In particular, such injuries can include fractured hip and pelvis, elbow, or wrist, all of which are common injuries of the elderly who often suffer from decreasing steadiness of feet as well.

As well, with the increasing prevalence of hand-held electronic devices, especially when in the hands of the young and energetic, there is an increasing instance of damage to such devices due to inadvertent drops and the like.

Of course, another arena of prospective injury and damage occurs on school playgrounds and fields of competition due to the design of long-standing ball games. For example, one cannot expect a defensive football tackle to approach an opponent ball carrier with less than full force, and so collisions that result in significant transmitted force to the bodies of football players, as well as players of many other sports, is an inevitable and expected part of the game. It is also expected that young children will fall, collide, and otherwise have contacts between themselves and lesser movable objects in the course of ordinary play; and some of those contacts result in significant injury.

A material having a structure for absorbing at least some of the force of impact may lessen if not wholly counteract the potential injury or damage that commonly occurs with the impacts noted above. It is an object of the present invention to provide such a material.

### SUMMARY OF THE INVENTION

The present invention in its various embodiments provides a material that includes (a) a first elastic element and a second elastic element that are (a) adjacent but not contiguous when in a resting state and (b) connected to a substantially inelastic element, wherein both of the elastic elements are disposed on the exterior surface of the material and the first elastic or the second elastic element spreads laterally upon impact with an object. In a further embodiment, the material comprises a multiplicity of elastic elements; wherein, further, at least some of the multiplicity of elastic elements are distributed on the material in a non-contiguous fashion relative to other elastic elements when in a resting state. In certain embodiments, each elastic element is not contiguous with an adjacent elastic element.

Generally, the inventive material includes at least some of the multiplicity of elastic elements distributed on the material in a non-contiguous fashion relative to other elastic elements. In another embodiment, the elastic elements deform upon impact with an object.

Generally, the elastic element of the inventive material is comprised of an elastomer, which elastomer can be one or more of the group consisting of natural rubber, synthetic polyisoprene, polybutadiene, polychloropene, a copolymer of isobutylene and isoprene, a copolymer of styrene and butadiene, a copolymer of acrylonitrile and butadiene, a copolymer of ethylene and propylene, a terpolymer of ethylene, propylene and a diene-component, epichlorohydrin rubber, a polyacrylic rubber, a silicone rubber, a fluorosilicone rubber, a fluoroelastomer, a perfluoroelastomer, a polyether block amide, chlorosulfonated polyethylene, ethylene-vinyl acetate, a thermoplastic elastomer, resilin, elastin, a polysulfide rubber, and elastolefin. In another embodiment, the elastomer is one or more of the group consisting of natural rubber, synthetic polyisoprene, epichlorohydrin rubber, a polyacrylic rubber, a silicone rubber, a fluorosilicone rubber, a fluoroelastomer, and a perfluoroelastomer. And in yet another embodiment, the elastomer is one or more of the group consisting of polyisoprene, polybutadiene, polychloropene, a copolymer of isobutylene and isoprene, a copolymer of styrene and butadiene, a copolymer of acrylonitrile and butadiene, a copolymer of ethylene and propylene, a terpolymer of ethylene, propylene and a diene-component.

The elastic elements of the inventive material have a shape, wherein the shape is selected from the group consisting of a flower, a circle, an oval, a square, a rectangle, a gear-shape, a polygon, a star, a shield, a heart, a spiral, a letter, a wave, an emoji, and a crescent.

Generally, the inelastic element of the inventive material is a sheet that insubstantially deforms upon impact with an object. The sheet is comprised of a polymer or a metal.

In some embodiments, the inventive material further includes a cushioning element that is disposed on the interior surface of the material; and can further include an adhesive disposed on the interior surface of the material.

The inventive material can be used in the context of an article wherein the material is positioned to protect a user's knee, hip, pelvis, elbow, shoulder, or head. The article can be clothing or protective gear as used for participants of a contact sport or a cyclist or a motorcyclist. The inventive material can also be used to protect delicate objects by attachment to portions thereof that can soften impact if the inventive material is in place.

### BRIEF DESCRIPTION OF THE FIGURES

FIG. 1 is a top or outside view of an impact-absorbing material of the present invention.

FIGS. 2a and 2b are side views of one embodiment of the impact-absorbing material of the present invention, showing the top or outside layer on top, a middle layer, and then a bottom or inside layer, respectively before and after an impact with an object or person.

FIGS. 3a and 3b are side views of another embodiment of the impact-absorbing material of the present invention, again showing the top or outside layer on top, a middle layer, and then a bottom or inside layer, respectively before and after an impact with an object or person.

FIGS. 4A and 4B are top or outside views of two embodiments of the impact-absorbing material of the present invention.

FIG. 5 is a chart of shapes of the impact-absorbing material usefully employed in different embodiments of the impact-absorbing material of the present invention.

FIG. 6 is a drawing of a patch comprising the impact-absorbing material of the present invention that is attached to a pair of shorts, as applied for protection of a user's hip.

FIG. 7 is a drawing of a pair of shorts that includes the impact-absorbing material of the present invention as applied for protection of a user's hip.

FIG. 8 is a drawing of a shirt and trousers comprised of the impact-absorbing material of the present invention as applied for protection of shoulders, elbows, and knees.

FIG. 9 is a drawing of another embodiment of the present invention employed in a shirt and trousers for protection of elbows, hip and tail bone, and knees.

FIG. 10 is a drawing of a jacket or coat comprised of the impact-absorbing material of the present invention as applied for protection of shoulders, elbows, and hip and tail bone.

### DETAILED DESCRIPTION OF THE PREFERRED EMBODIMENTS

The present invention relates to an impact-absorbing material that includes elastic elements that absorb or dissipate energy upon collision between the material and an object. As used herein, the present invention is referred to synonymously as “impact-absorbing” or “shock-absorbing” material. Given that the inventive material is intended to protect an individual wearing an article of clothing or protective gear that is comprised of the inventive material, more particularly the protective quality engendered by the elastic elements is intended to protect the individual from harm due to such a collision. More particularly, articles that incorporate the impact-absorbing material, as well as patches of such material for application to an article, are contemplated as embodiments of the present invention. Articles that can be manufactured or later altered with the inventive material include clothing or protective gear such as that used by participants of a contact sport or a motorcyclist, for example without intention to limit whatsoever.

In another aspect, the inventive material is used in manufacture of materials that can be attached to a fragile device so that it has an increased likelihood of surviving a collision due to a drop or otherwise. For example, swatches of the inventive material having an adhesive on its inside can be cut to approximate the sides and/or edges of an electronic device, such as, for example and without limitation intended a mobile phone, an electronic tablet, or a laptop computer. Placement of such swatches on the electronic device at its edges absorbs kinetic energy that occurs upon dropping thereby giving the owner of such a device a protection against damage that would be otherwise likely due to an unfortunate drop.

In yet another aspect, the inventive material is used in manufacture of protective gear used to protect players involved in contact sports, bicycling, motorcycling, or rafting, for example without limitation intended. Protective gear includes a helmet or elbow guard or shin guard or protection for any other body location prone to injury due to collisions on a playing field, on the road or track, in the water, and the like. The placement of the inventive material on the outside of the protective gear is typically in addition to cushioning of prior art protective gear that is placed on the inside immediately adjacent the user's body. Of course, in some embodiments, the inventive material includes cushioning to be located adjacent the user's body when in use. As in the example of fragile devices, one can also apply the inventive material to an existing item of protective gear to gain the added protection provided by the present invention.

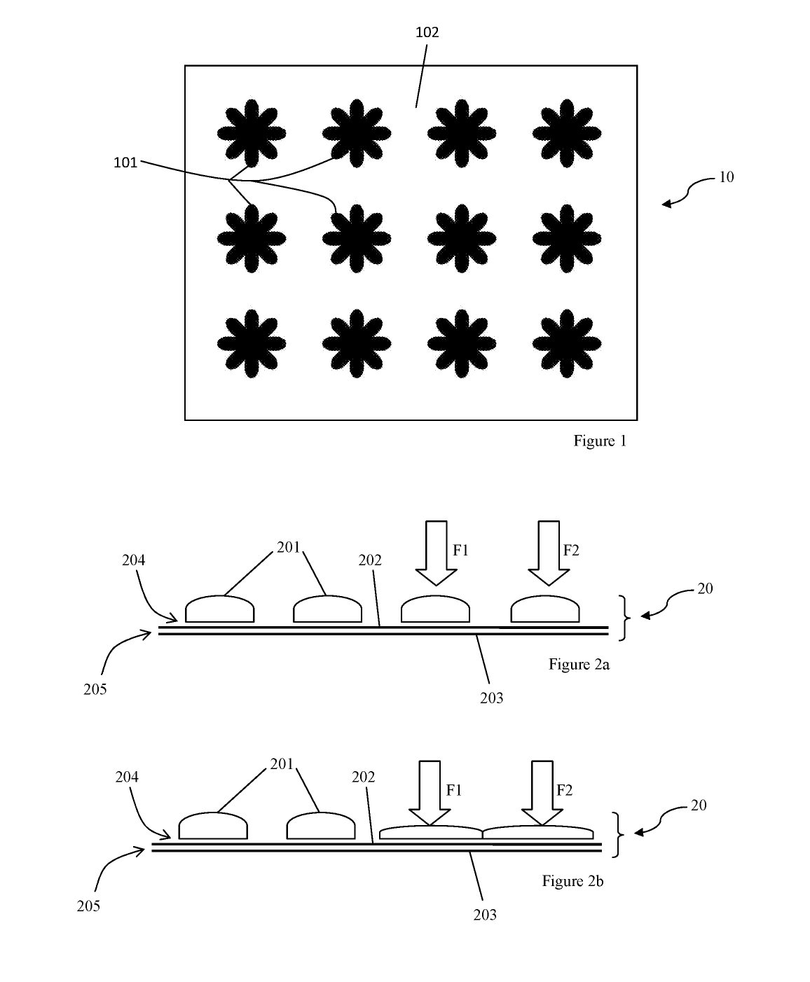

Turning to FIG. 1, the impact-absorbing material 10 is shown from its exterior or outside surface, referred to herein as a top view, wherein two components of the inventive material can be seen: a substantially inelastic element 102 and an elastic element 101. As shown in FIG. 1, the material includes a multiplicity of elastic elements 101. The elastic elements 101 in FIG. 1 have the shape of a multi-petaled flower; however, in other embodiments, the elastic elements can have any shape one may imagine, including any geometric shape, such as a regular or irregular polygon, as well as shapes that defy ready mathematical description, including, for example, an ideogram used commonly in electronic messages and web pages (also referred to as emoji or emoticons). As shown in FIG. 1, it is generally the case that the elastic elements are placed with a space between each one where the spacing is generally the same, but not necessarily so.

Adjacent elastic elements can be contiguous or not contiguous, but are generally placed such that at least some of the adjacent elastic elements are not contiguous. The inventive material generally includes a first elastic element and a second elastic element that, when in a resting state, are (a) adjacent but not contiguous and (b) connected to a substantially inelastic element, wherein both of the elastic elements are disposed on the exterior surface of the material and the first elastic element or the second elastic element spreads laterally upon impact with an object. The term “resting state” refers to the state of the material prior to coming into contact with an object, commonly referred to herein as an impact or collision.

In another embodiment of the present invention, all of the adjacent elastic elements are not contiguous when in the resting state. The meaning of adjacent elastic elements being “not contiguous” is that, in the resting state, they make no contact one with the other. The open space between adjacent elastic elements is purposefully employed as the place where the inventive material can laterally move upon a forceful impact with an object. Accordingly, prior art that shows adjacent single-variety elements or adjacent multiple variety elements contiguously disposed or, simply, a sheet of a single material, are distinct from the present invention.

In general, the elastic elements are positioned on the impact-absorbing material so that, upon impact, the stricken elastic element spreads laterally to cover an increased area on its plane of attachment. In some embodiments, the extent of increased area over which the elastic element spreads in any direction approximates the midway point between two adjacent elastic elements. By so positioning the elastic elements and using a material therefor that is able to compress top to bottom and spread laterally upon receipt of a force of impact, the force is (a) dissipated and (b) spread over a wider area than without inclusion of the inventive material.

More particularly, turning to FIGS. 2a and 2b, the just stated points can be described where the shock-absorbing material 20 is shown in cross-section. One can see that the shock-absorbing material 20 includes a multiplicity of elastic elements 201, a sheet of a substantially inelastic element 202, and an optional interior cushioning element 203 that is itself, when included, attached by mechanical, chemical or physical means to the substantially inelastic element 202 at position 205. (The mechanical, chemical or physical means used to attach one element to another are described by examples below.) Each of the elastic elements 201 is in contact with the substantially inelastic element 202 and is attached thereto along the opposing surfaces indicated by location 204.

The position of an elastic element 201 relative to adjacent elastic elements relates to characteristics of the actual material employed because it is intended that each elastic element involved in a collision with an object will compress from point of contact on the outside surface toward the inelastic element 202. A consequence of the compression of the impacted elastic element 201 is the expansion of lateral area that the elastic element covers. For example, potential impacts with an object is represented in FIG. 2a by the arrows F1 and F2, indicating that a force will be received by the absorbing material if the potential is realized. FIG. 2b depicts the consequence of the impact, where two elastic elements 201 respectively are contacted by an object or objects (indicated by contact of arrows F1 and F2 on the elastic elements), resulting in the reduction in the vertical dimension of the impacted elastic elements (shown to be of lesser height in FIG. 2b relative to that of FIG. 2a). A further consequence of the impact is the expansion in the lateral dimension of the same elastic elements, such that, as shown in FIG. 2b, the impacted adjacent elastic elements then are in contact one with the other.

The attachment between the individual elastic elements and the substantially inelastic element can be by mechanical or chemical means using, for example, one or more stitches, staples, or the like, or a glue known in the art for materials employed for the present invention. The attachment can also be stabilized physically by a heat fusion of the adjoining material of the elastic element 201 and the substantially inelastic element 202. The placement of the elastic elements relative to each other can depend on the characteristic to spread laterally upon impact with an object. Preferably, the distance between adjacent elastic elements is twice the lateral expansion expected due to impact of an object on one of the elastic elements. Upon impact, as shown in FIG. 2b, the lateral displacement of impacted adjacent elastic elements can cause the elastic elements to touch one another.

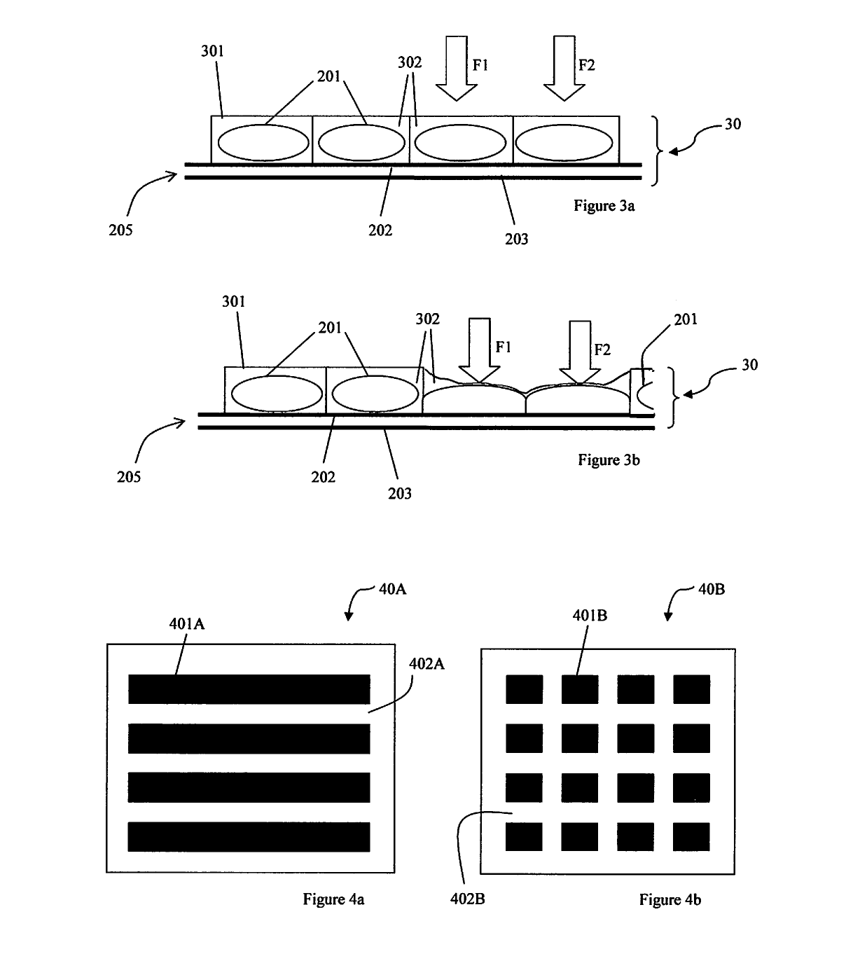

In another embodiment (described further below and shown in FIGS. 3a and 3b), the inventive material 30 can include elastic elements 201 contained in “bubbles” 302 having a “skin” 301 composed of a less elastic material than that used for the elastic elements, such as a polyvinylchloride; which bubbles are attached to the substantially inelastic element 202 that, in turn, is attached to the interior cushion element 203. As in the embodiment of FIGS. 2a and 2b, the interior cushion element 203 is optional, meaning in some embodiments the inventive material is a combination of bubble, elastic element, and substantially inelastic element only. The containment of the elastic elements in the “bubbles” can be attained by co-extrusion methods of manufacture as known in the art. The so-contained elastic elements 201 are then attached to the substantially inelastic element 202 as a sheet of elastic element-containing bubbles 302 having an outer surface 301 using one of the aforementioned mechanical, chemical or physical attachment means. As included in the embodiment of FIGS. 2a and 2b, there is also shown here an interior cushion layer 203 that is typically composed of a polymer as further described below. Analogous to the impact scenario described above for FIGS. 2a and 2b, impact of the inventive material with an object transfers a force F1 and F2 that results in compression of the impacted bubbles and elastic elements 201 such that the bubbles collapse at least in part and the elastic elements 201 compress and spread laterally to the point of contacting one another as shown in FIG. 3b.

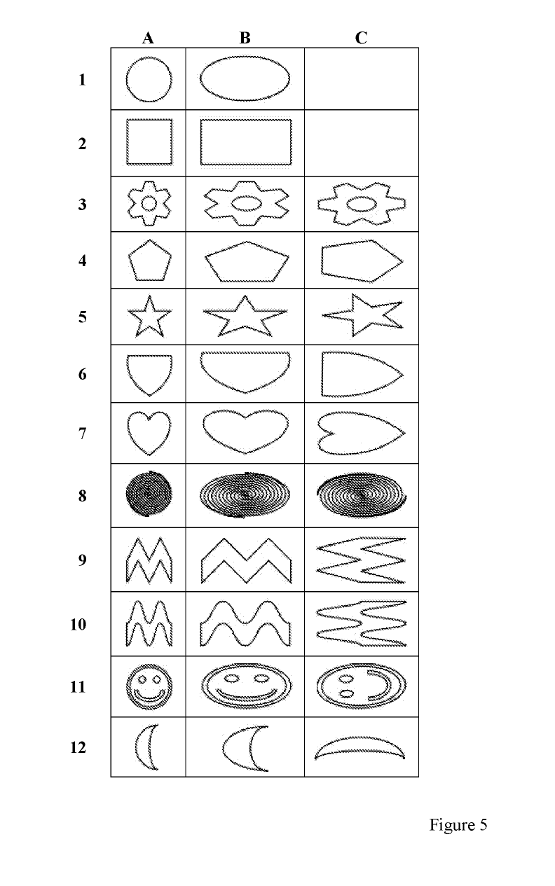

A representative, non-limiting assemblage of exemplary shapes that may be employed for the elastic elements of the present invention is shown in FIG. 5, which includes a circle A1, oval B1, square A2, rectangle B2, a gear-shape A3 or stretched gear-shape B3 or C3, a regular pentagon A4 or a stretched pentagon B4 or C4, a regular five-pointed star A5 or a stretched five-pointed star B5 or C5, a regular shield-shape A6 or a stretched shield shape B6 or C6, a regular heart-shape A7 or a stretched heart-shape B7 or C7, a circular spiral shape A8 or an oval spiral shape B8 or C8, an acute-angled zig-zag shape A9, a right-angled zig-zag shape B9, an elongate acute-angled zig-zag shape C9, a wave shape A10, B10, or C10, a smiley face emoji A11, a stretched smiley face emoji B11 or C11, or a crescent A12 or a stretched crescent B12 or C12. FIG. 4A presents a top view of another embodiment of the invention where the impact-absorbing material 40A has a multiplicity of strips of elastic elements 401A attached to the substantially inelastic element 402A. FIG. 4B presents a top view of yet another embodiment of the invention where the impact-absorbing material 40B has a checkerboard pattern of elastic elements 401B attached to the substantially inelastic element 402B. Some embodiments of the present invention include uniformly shaped elastic elements 201; other embodiments employ two or three, or more differently shaped elastic elements 201. All embodiments of the present invention include voids between the respective elastic elements of the multiplicity of elastic elements that comprises the protective material.

In certain embodiments of the present invention, damaged individual elastic elements can be replaced on a given piece of inventive material by removing mechanically (i.e., cutting out) the damaged elastic element or elements and substituting therefor replacement elastic elements.

The elastic elements are made from any suitable material that imparts an ability to reversibly deform upon impact and absorb or dissipate kinetic energy. The deformation upon impact occurs in consequence of at least some of the energy received, where the kinetic energy of the moving bodies that collide is absorbed in part by the energy required to deform the elastic element. The stiffer the elastic element is, the more energy will be required to result in the deformation. On the other hand, the stiffer the elastic element is, the more energy may be transferred to the interior side of the inventive material and therefore to the individual or thing wearing or enclosed by the inventive material. Accordingly, there is a need to use elastic elements whose ability to deform is sufficiently facile to permit deformation and thus reduce or dampen the energy that is transmitted to the interior side of the inventive material. The present invention includes use of voids in the same plane between the elastic elements, thereby increasing the ability of the elastic elements to deform and thereby absorb energy from the impact.

Suitable materials used for manufacture of the elastic element of the present invention are predominantly elastomers. An elastomer usefully employed for the elastic elements is selected from the group consisting of natural rubber (i.e., natural polyisoprene, which is a combination of cis-1,4-polyisoprene and trans-1,4-polyisoprene), synthetic polyisoprene, polybutadiene, polychloropene (also known as neoprene), a copolymer of isobutylene and isoprene, a copolymer of styrene and butadiene, a copolymer of acrylonitrile and butadiene, a copolymer of ethylene and propylene, a terpolymer of ethylene, propylene and a diene-component, epichlorohydrin rubber, a polyacrylic rubber, a silicone rubber, a fluorosilicone rubber, a fluoroelastomer, a perfluoroelastomer, a polyether block amide, a chlorosulfonated polyethylene, ethylene-vinyl acetate, a thermoplastic elastomer, an elastic protein, such as resilin or elastin, a polysulfide rubber, and elastolefin. Apart from resilin and elastin, which are proteins, the materials listed above are natural or synthetic plastics.

Other suitable materials for manufacture of the elastic element include polymeric foam materials. Examples of suitable polymeric foams include phenolic resin foams, polystyrene foams, polyurethane foams, polyethylene foams, polyvinylchloride foams, polyvinyl-acetate foams, polyester foams, polyether foams, and foam rubber. These polymeric foam materials include those that are known as “rate-sensitive materials,” i.e., materials known in the art that are composed of at least two different polymers, the combination of which exhibits a non-newtonian stress-strain profile where the material exhibits a resistive load under deformation that increases with the rate of deformation. Due to this characteristic, such materials are particularly useful for decelerating impact-associated energies experienced in an accidental fall, for example. Suitable rate-sensitive materials usefully employed in the context of the present invention include rate-sensitive polyurethane foams, including, for example, microcellular open-cell polyurethane foams. Such materials are available from the Rogers Corporation, particularly its products marketed under the trade names PORON® and PORON XRD®.

All of the materials usefully employed as the elastic element of the present invention are well-known in the art and can be manufactured or purchased readily by appropriate artisans. A source for purchase of the above-identified elastic materials, in addition to the Rogers Corporation, is Sigma-Aldrich Co., St. Louis, Mo.

In one embodiment, the elastomer is selected from the group consisting of natural rubber, synthetic polyisoprene, epichlorohydrin rubber, a polyacrylic rubber, a silicone rubber, a fluorosilicone rubber, a fluoroelastomer, and a perfluoroelastomer.

In another embodiment, the elastomer is selected from the group consisting of polyisoprene, polybutadiene, polychloropene, a copolymer of isobutylene and isoprene, a copolymer of styrene and butadiene, a copolymer of acrylonitrile and butadiene, a copolymer of ethylene and propylene, a terpolymer of ethylene, propylene and a diene-component.

In yet another embodiment, the elastomer is natural or synthetic polyisoprene.

And in yet another embodiment, the elastomer is a rate-sensitive material.

The substantially inelastic element 202 provides a surface against which the elastic element 201 depresses when a collision occurs such that the elastic element 201 deforms and spreads laterally upon the surface of the substantially inelastic element 202. One embodiment of the present invention spaces the elastic elements so that upon collision adjacent elastic elements do not touch one another upon deformation due to the collision. In other embodiments, the elastic elements are spaced so that they touch at their respective edges only upon collision with another object.

Turning to FIGS. 2a and 2b for reviewing how the present invention serves to dissipate force of an impact with an object, the elastic elements spaced apart from one another. Prior to impact with the object, represented by the force arrows F1 and F2 in FIG. 2a indicating no contact with the impact-absorbing material 20 by not being in contact, the elastic elements each have a height x. Upon contact with the object, symbolized by the force arrows F1 and F2 in FIG. 2b being in contact with the elastic elements, the elastic elements that received the force are shown having a substantially reduced height. Moreover, the elastic elements in contact with the force have spread out laterally to the point that, in some embodiments, including that shown in FIG. 2b, the elastic elements touch at their respective lateral edges. Upon removal of the force on the impacted elastic elements, the elastic elements substantially return to their respective original shapes and are available to absorb or dissipate the energy from a subsequent contact.

In another embodiment of the present invention, the elastic element is co-extruded with a plastic material that encases the elastic element, as shown for the impact-absorbing material 30 shown in FIGS. 3a and 3b. There, the elastic element 201 can be seen to be encased by an encasing element 301, which, as noted, is formed of a plastic; and commonly is formed of a polyvinylchloride (PVC). Upon impact with a second object, the elastic element 201 spreads laterally filling at least a portion of the void 302 formed by the plastic material; and, as in the example depicted in FIGS. 2a/2b, reduces in height as it spreads out due to the received force indicated by the force arrows F1 and F2. The “bubble” 301 that surrounds the elastic element is caused to collapse down due to the impact, as shown in FIG. 3b.

The co-extrusion process is well-known in the art and can be undertaken by an artisan familiar with the methods of the relevant field.

The innermost layer of the present invention, noted to be the cushioning element 203, serves as another layer of padding to protect a user further from energy transfer of a collision. In most embodiments, the cushion element 203 is in contact with the substantially inelastic element 202, and is attached using attachment means well known in the art. The attachment means include mechanical, chemical, or physical means such as, for example, stitches, staples, rivets, hook-and-eye material (e.g., Velcro materials), glue, solvent, and heat; applied per standard methods well known in the art.

The cushioning element 203 is preferably composed of any elastic material, including those described above with respect to the elastic element 201.

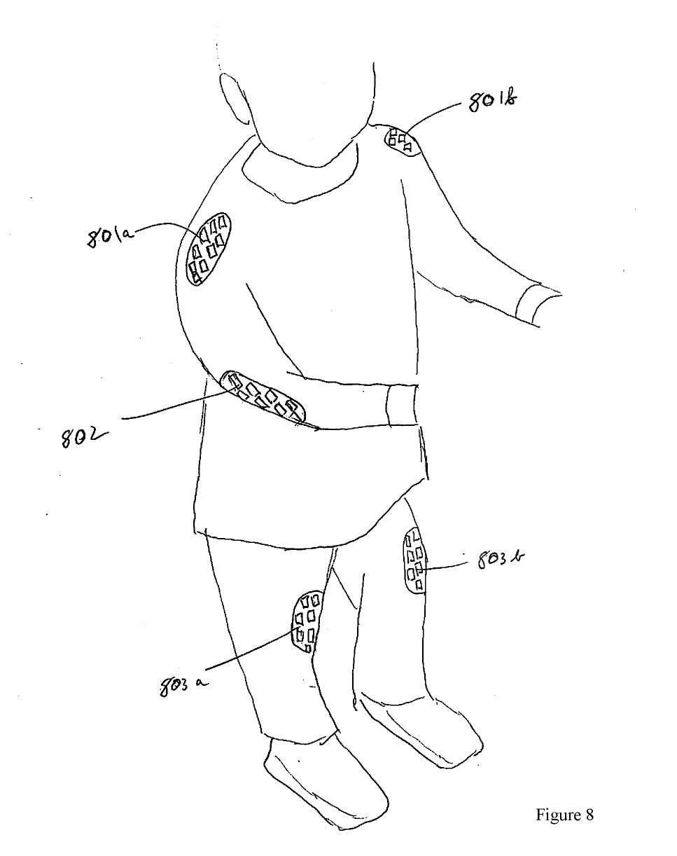

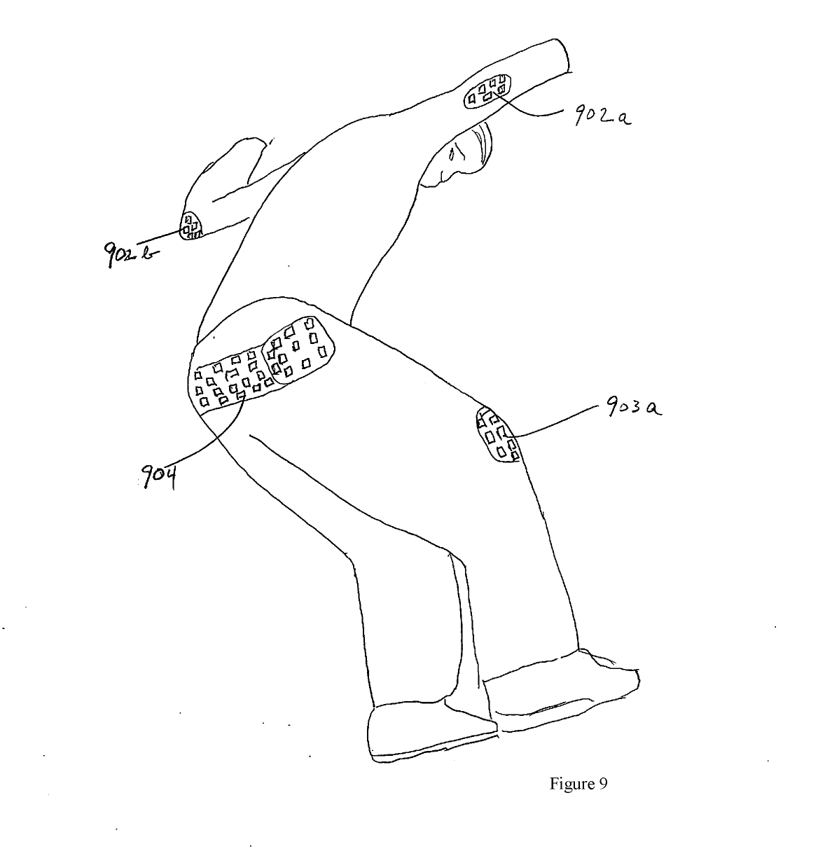

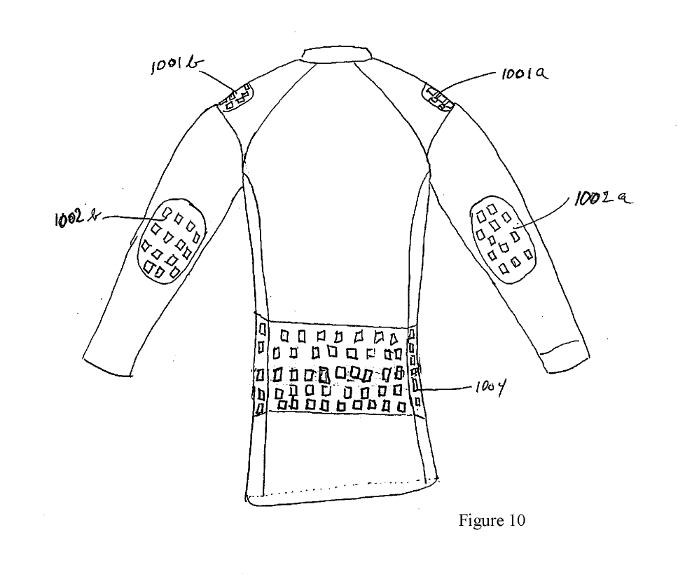

The shock-absorbing material 10, 20, 30, 40A, or 40B of the present invention can be prepared in any shape and used in the manufacture of clothing and other materials. Accordingly, one can have a shirt that includes the shock-absorbing material for protecting a user's shoulders and elbows, as shown in FIGS. 8 and 9 (see positions 801a, 801b, 802, 902a, and 902b). A pair of pants can also include protective shock absorbing material (see positions 803a, 803b, 903a and 904). An outer coat, as shown in FIG. 10, can also be manufactured using the shock-absorbing material of the present invention. Accordingly, a user's shoulders (positions 1001a, 1001b), elbows (positions 1002a, 1002b), hip and tail bone areas (position 1004) can have added protection due to the materials included in the manufacture of the coat. As noted above, instead of incorporating the impact-absorbing material into the manufacture of the piece of clothing, one can apply patches of the inventive material for the same purpose. The inventive material can be attached in a permanent manner by sewing same or other attachment means, including, without limitation intended, hook-and-loop material, specialized cloth glue, and the like.

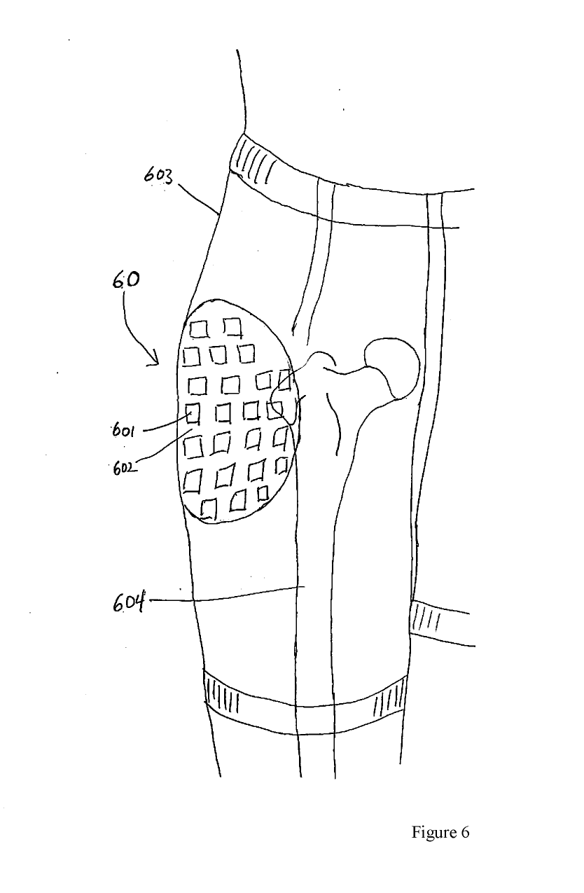

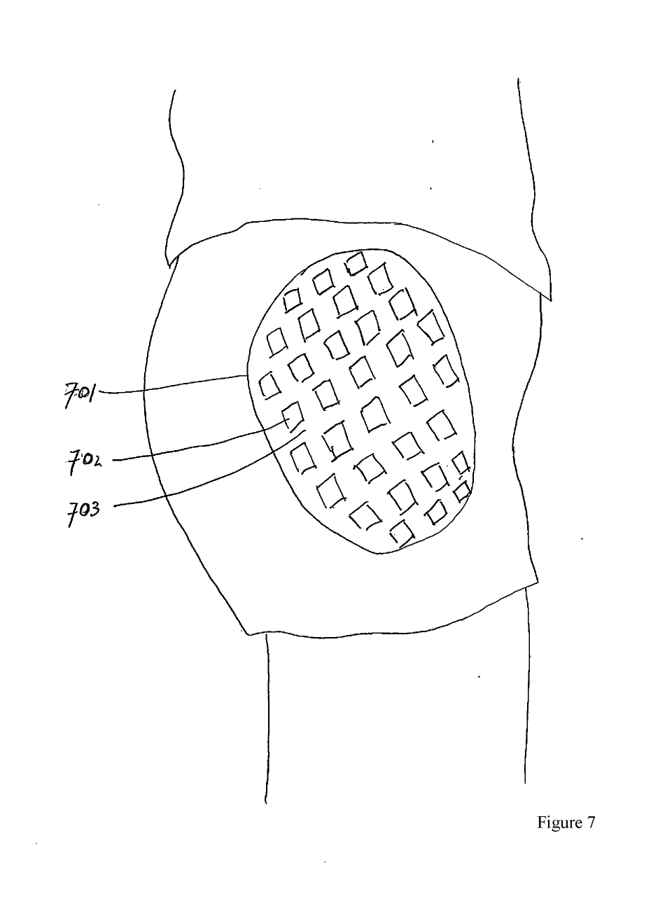

The protective aspects can also be built into shorts to protect one's hip or tail bone areas. See FIGS. 6 and 7. As shown on the pair of shorts 603 in FIG. 6, using the shock-absorbing material 60 of the present invention in at least the area adjacent one's hip, the elastic elements 601 and substantially inelastic element 601 of the shock-absorbing material can protect the hip area and further portions of one's femur 604 from inadvertent injury due to a collision. Similarly, the shorts shown in FIG. 7 includes an area comprised of the inventive material 701, where one can see the elastic elements 702 and the substantially inelastic element 703; positioned to protect the user's hip joint area.

Instead of the shown clothing of FIGS. 8 and 9 being prepared with the shock-absorbing material as just described, another embodiment of the present invention forms the shock-absorbing material into patches that can be attached to a user's clothing in strategic places, as shown in FIGS. 8 and 9. Such patches can be attached using methods well known in the art, including, without limitation intended, needle and thread or hook-and-loop attachment or glue. In addition, the clothing can be manufactured with pockets placed at strategic positions where swatches of the inventive material can be inserted to provide protection.

As indicated herein above, the present invention also includes use of the inventive material in combination with a container designed for the storage or mailing of a fragile device. Placement of protective elements 201 of the present invention in a container at points of contact of the to-be-enclosed fragile device can lend additional protection to the fragile device knowing that parcels are not necessarily treated gently when in transit. Such containers can be manufactured as such or, as indicated above for used with other objects, protective elements 201 having a sticky surface can be strategically placed in packaging to provide the desired added protection.

It will be appreciated by those skilled in the art that changes could be made to the embodiments described hereinabove without departing from the broad concepts disclosed therein. It is understood, therefore, that this disclosure is not limited to the particular embodiments disclosed, but it is intended to cover modifications that may include a combination of features illustrated in one or more embodiments with features illustrated in any other embodiments. Various modifications, equivalent processes, as well as numerous structures to which the present disclosure may be applicable will be readily apparent to those of skill in the art to which the present disclosure is directed upon review of the present specification. Accordingly, this description is to be construed as illustrative only and is presented for the purpose of enabling those skilled in the art to make and use the proximal catheter hubs described herein and to teach the best mode of carrying out the same.

We claim:

1. A material comprising a first elastic element and a second elastic element that are (a) adjacent but not contiguous in a resting state and (b) connected to a substantially inelastic element, wherein both of the elastic elements are disposed on the exterior surface of the material and the first elastic element or the second elastic element spreads laterally upon impact with an object.

2. The material of claim 1, wherein the material further comprises a multiplicity of elastic elements.

3. The material of claim 2, wherein at least some of the multiplicity of elastic elements are distributed on the material in a non-contiguous fashion relative to other elastic elements when in a resting state.

4. The material of claim 3, wherein each elastic element is not contiguous with an adjacent elastic element.

5. The material of claim 3, wherein the elastic elements deform upon impact with an object.

6. The material of claim 1, wherein the elastic element is comprised of an elastomer.

7. The material of claim 6, wherein the elastomer is one or more of the group consisting of natural rubber, synthetic polyisoprene, polybutadiene, polychloropene, a copolymer of isobutylene and isoprene, a copolymer of styrene and butadiene, a copolymer of acrylonitrile and butadiene, a copolymer of ethylene and propylene, a terpolymer of ethylene, propylene and a diene-component, epichlorohydrin rubber, a polyacrylic rubber, a silicone rubber, a fluorosilicone rubber, a fluoroelastomer, a perfluoroelastomer, a polyether block amide, chlorosulfonated polyethylene, ethylene-vinyl acetate, a thermoplastic elastomer, resilin, elastin, a polysulfide rubber, and elastolefin.

8. The material of claim 7, wherein the elastomer is one or more of the group consisting of natural rubber, synthetic polyisoprene, epichlorohydrin rubber, a polyacrylic rubber, a silicone rubber, a fluorosilicone rubber, a fluoroelastomer, and a perfluoroelastomer.

9. The material of claim 7, wherein the elastomer is one or more of the group consisting of polyisoprene, polybutadiene, polychloropene, a copolymer of isobutylene and isoprene, a copolymer of styrene and butadiene, a copolymer of acrylonitrile and butadiene, a copolymer of ethylene and propylene, a terpolymer of ethylene, propylene and a diene-component.

10. The material of claim 3, wherein the elastic elements have a shape.

11. The material of claim 10, wherein the shape is selected from the group consisting of a flower, a circle, an oval, a square, a rectangle, a gear-shape, a polygon, a star, a shield, a heart, a spiral, a letter, a wave, an emoji, and a crescent.

12. The material of claim 1, wherein the inelastic element is a sheet that insubstantially deforms upon impact with an object.

13. The material of claim 12, wherein the sheet is comprised of a polymer or a metal.

14. The material of claim 1, further comprising a cushioning element that is disposed on the interior surface of the material.

15. The material of claim 1, further comprising an adhesive disposed on the interior surface of the material.

16. An article comprising the material of claim 1, wherein the material is positioned to protect a user's knee, hip, pelvis, elbow, shoulder, or head.

17. A container comprising the material of claim 1.

18. The article of claim 15, wherein the article is clothing.

19. The article of claim 15, wherein the article is protective gear for a participant of a sport.

20. The article of claim 19, wherein the article is a helmet.
